(19) United States
(12) Patent Application Publication
(10) Pub. No.: US 2005/0213268 A1
(43) Pub. Date: Sep. 29, 2005

(54) Method and circuit for improving device power up timing and predictability

(76) Inventors: Joseph Cetin, San Diego, CA (US); Nathan Moyal, West Linn, OR (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/088,029

(22) Filed: Mar. 22, 2005

Related U.S. Application Data
(60) Provisional application No. 60/556,968, filed on Mar. 26, 2004.

(51) Int. Cl. H02H 7/00

(52) U.S. Cl. 361/18

(57) ABSTRACT

Method and system for controllably and sequentially powering up subsystems of an electronic system, device or integrated circuit. In one example, a first supply voltage is selectively applied to a first subsystem, and when the first supply voltage has reached a predetermined value, a second supply voltage is selectively applied to the second subsystem. The first and second supply voltages may also be boosted to provide fast startup timing. In this manner, the first subsystem is powered-up before the second supply voltage is applied to the second subsystem—this provides for controlled, sequential power up of the subsystems of the electronic system, device or integrated circuit.

### CROSS REFERENCE TO RELATED APPLICATION

This application claims priority under 35 U.S.C. 119(e) to U.S. provisional patent application Ser. No. 60/556,968 filed Mar. 26, 2004 and entitled “Method of Improving Device Power Up Timing and Predictability,” the disclosure of which is hereby incorporated by reference in its entirety.

### FIELD OF THE INVENTION

This invention relates, in general, to electronic circuits, and in particular to circuits for controlling power in an integrated circuit or electronic system.

### BACKGROUND OF THE INVENTION

Many devices or systems, particularly those using low voltages and consuming low power, require a voltage regulator, either internal or external, that provides a regulated supply voltage. Low voltage regulators are frequently used in low voltage or low power devices. Typically, an output of a voltage regulator is applied to the entire device or system, which can cause some drawbacks. A first drawback is that power up speed of the device or system may be limited by the performance/specifications of the voltage regulator. A second drawback is that the device or system which uses the voltage regulator may have many sub-blocks, and once the regulator is activated, the sub-blocks may come up out of a power down state in a non-predictable or non-deterministic sequence. As recognized by the present inventors, certain sub-blocks of the device or system may need to come up out of their inactive state faster than other sub-blocks in order to avoid damage to or malfunction of the device or system.

One conventional power regulation approach 30 is shown in FIG. 1. In FIG. 1, an activate signal input 32 is provided to a voltage regulator 34 and the voltage regulator 34 takes a high voltage as an input 36 (shown in this example as 3.3 volts) and provides a steady lower voltage as its output 38 (shown in this example as 1.2 volts). The regulated voltage output 38 is provided to a low voltage and/or low power device or system 40. The active signal 32 activates the voltage regulator. Once the voltage regulator 32 is activated, the output 38 of the voltage regulator 34 is activated and current or voltage is applied to the device or system 40. The amount of time required to bring the device or system 40 to a particular voltage level is governed by the voltage regulator 34 and the environmental conditions of the device 40 (such as internal loading or external loading, represented as 42). The voltage regulator 34 may be internal or external to the device or system 40 depending on the implementation.

However, in FIG. 1, the power up timing of the device or system 40 may vary from device to device based on the amount of device loading, and for each sub-block within the device or system 40, the sequence of sub-block power up may depend on the loading of each sub-block which may be unpredictable. As these sub-blocks power up and start processing data or generating signals, internal gates may be used to block corrupt signals during power up so they do not pass through until the entire system 40 is properly powered-up. For example and as recognized by the present inventors, in a phase lock loop (PLL), it may be desirable to have the reference clock to be active before the PLL is active, but the unpredictability of conventional power up schemes such as of FIG. 1 may inhibit this.

As recognized by the present inventors, what is needed is a method and system for providing predictable power up sequencing and improved power up speed of a device or system and their sub-blocks or components.

It is against this background that various embodiments of the present invention were developed.

### SUMMARY

In light of the above and according to one broad aspect of one embodiment of the present invention, disclosed herein is a method of regulation of power within an integrated circuit. In one example, the integrated circuit has at least a first and a second subsystem therein, and the method may include the operations of selectively providing a first supply voltage to the first subsystem, detecting when the first supply voltage has reached a predetermined value, and selectively providing a second supply voltage to the second subsystem. In one example, the operation of selectively providing a second supply voltage occurs after the detecting operation, and the detecting operation may include comparing the first supply voltage to a reference voltage. In this manner, the first subsystem of the integrated circuit is powered-up before the second supply voltage is applied to the second subsystem—this provides for controlled, sequential power up of the subsystems of the integrated circuit.

Of course, if desired, the integrated circuit could be designed so that the second subsystem receives its regulated supply before the first subsystem, or other sequences are possible where there are numerous subsystems in the integrated circuit. For instance, this methodology could be applied to integrated circuits having multiple and numerous subsystems that are to be sequentially powered up in a desired order to avoid the problems identified above with conventional systems.

In another example, the method may also include boosting the first supply voltage to provide for faster power-up of the first supply voltage and the first subsystem. The method may also include boosting-the second supply voltage to provide for faster power-up of the second supply voltage and the second subsystem. Signals within or between subsystems that are bias signals or voltages may also be boosted or pre-biased for faster startup, so that these bias signals are providing their desired bias levels in a rapid time, which helps to improve the startup time of the subsystem containing the boosted bias signal.

According to another broad aspect of another embodiment of the present invention, disclosed herein is an integrated circuit having at least a first and second subsystem, the integrated circuit including at least a first controllable voltage regulator receiving selectively providing a first supply voltage to the first subsystem; at least a second controllable voltage regulator selectively providing a second supply voltage to the second subsystem; and a comparator for determining when the first supply voltage has reached a predetermined value.

The controllable voltage regulators may each includes a control input for selectively activating the respective voltage regulator output voltage. In one example, the predetermined value is a reference voltage that is provided as an input to the comparator. The reference value may, in one example, be a voltage that is substantially the desired value of the first supply voltage.

In another example, the integrated circuit may include a boost circuit for boosting the first supply voltage, and a boost circuit for boosting the second supply voltage. Signals within or between subsystems that are bias signals or voltages may also be boosted or pre-biased for faster startup, so that these bias. signals are providing their desired bias levels in a rapid time, which helps to improve the startup time of the subsystem containing the boosted bias signal.

According to another broad aspect of another embodiment of the present invention, disclosed herein is a voltage regulation system for a device having at least a first and second subsystem. In one example, the voltage regulation system may include a main power supply providing a first supply voltage; a first controllable voltage regulator receiving the first supply voltage and selectively providing a second supply voltage to the first subsystem beginning at a first time; and a second controllable voltage regulator receiving the first supply voltage and selectively providing a third supply voltage to the second subsystem beginning at a second time. In one example, the first controllable voltage regulator provides its regulated output before the second controllable voltage regulator provides its regulated output.

In another example, the voltage regulation system may also include means for boosting the second supply voltage including a comparator and a current source for boosting the second supply voltage to a predetermined voltage. The first and second controllable voltage regulators may each include a control signal input for selectively activating their regulated supply outputs.

The main power supply may be external to the device, or internal to the device. The device may be an integrated circuit and the first and second subsystems may be within or external to the integrated circuit.

According to another embodiment, a method is disclosed for providing predictable power-up sequences for a device or system, in accordance with an embodiment of the present invention, which can be used for starting up circuits that otherwise do not have deterministic relationships of clock and data, thereby to avoid metastability. The method can also be used to more rapidly bring a device out of power-down (sleep) state.

The features, utilities and advantages of the various embodiments of the invention will be apparent from the following more particular description of embodiments of the invention as illustrated in the accompanying drawings.

### BRIEF DESCRIPTION OF THE DRAWINGS

FIG. 1 is a conventional voltage regulator for a device or system, having a generally unpredictable power-up sequence.

FIG. 2 illustrates an example of an improved voltage regulator arrangement, including boost circuits, in accordance with an embodiment of the present invention.

FIG. 3 illustrates another example of a voltage regulation to power up sub-blocks in a specific sequence, in accordance with an embodiment of the present invention.

FIG. 4 illustrates an example of operations for providing predictable power-up sequences for a device or system, in accordance with an embodiment of the present invention.

### DETAILED DESCRIPTION

Embodiments of the present invention provide predictable startup sequencing and priority control of one or more sections, blocks, circuits, components or subsystems (referred to herein interchangeably as “subsystems”) either within an integrated circuit or device, or distributed amongst discrete circuit components of an electronic system. Embodiments of the invention may also provide improved or faster start-up timing of circuits or subsystems, if desired. For instance, boost circuits can be used to boost supply lines or bias lines, and these boost circuits can also be used to indicate when a subsystem has a stable supply or bias signal. Various embodiments of the present invention will now be described.

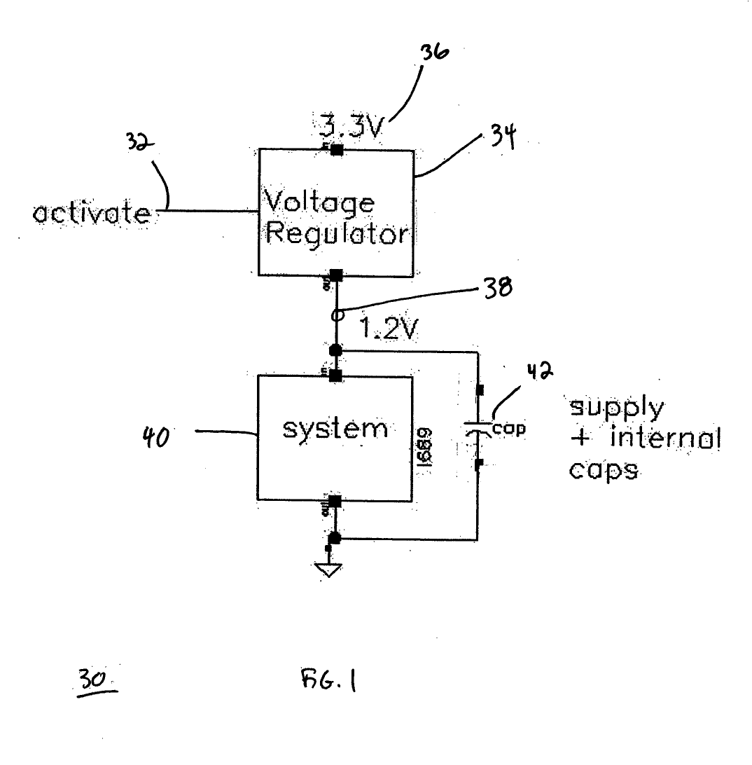

In one example, one or more voltage controllable regulators are provided and associated with one or more subsystems of a device or system. A controllable voltage regulator may be provided to supply a regulated voltage supply signal to a particular subsystem of an overall electronic system or device. This is in contrast with conventional designs such as in FIG. 1 wherein a voltage regulator provides a regulated voltage output used throughout the entire electronic system. For simplicity of this description, a voltage regulator is shown and described; however, it is understood that a current regulator or other conventional regulator could be used instead. Accordingly, the terms voltage regulator and current regulator are used interchangeably herein.

Likewise, voltage supply signals and voltage bias signals are shown and described; however, it is understood that current supply signals or current bias signals could be used instead. Accordingly, the terms voltage supply, power supply, current supply, voltage bias, and current bias are used interchangeably herein.

In one example, a first supply voltage is selectively applied to a first subsystem, and when the first supply voltage has reached a predetermined value, a second supply voltage is selectively applied to the second subsystem. The first and second supply voltages may also be boosted to provide fast startup timing. In this manner, the first subsystem is powered-up before the second supply voltage is applied to the second subsystem—this provides for controlled, sequential power up of the subsystems of the electronic system, device or integrated circuit.

In one example, each controllable voltage regulator associated with a particular subsystem is controllable through a control signal, which governs whether the voltage regulator is enabled or provides a regulated voltage output. For instance, if a controllable voltage regulator receives a sufficient supply signal, the voltage regulator could provide a regulated voltage output if the control signal input to the voltage regulator is active. In this way, once the system or device receives initial power and the initial power is applied to the various controllable voltage regulators of the system, the controllable voltage regulators can then be used to selectively supply regulated power to certain subsystems of the electronic system or device in a prioritized manner. After each subsystem receives power in sequence, the entire device or system is operational.

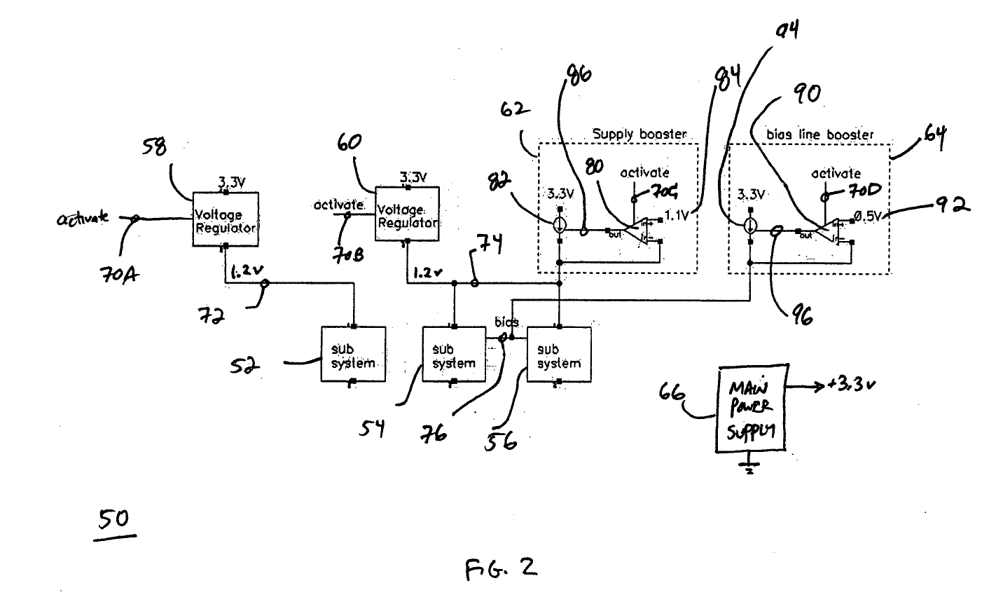

FIG. 2 illustrates an example of an electronic system or device 50 being powered up in a controlled and prioritized manner. In this example, the system or device 50 includes subsystems 52, 54 and 56, and controllable voltage regulators 58, 60 are provided along with supply booster 62 and bias line booster 64. It is understood that FIG. 2 is provided for illustrative purposes only and that other devices or systems may include fewer or greater numbers of subsystems, voltage regulators, or boosters.

In one example, the system or device 50 may include one or more main power supplies 66 which provide a first level of power to the plurality of voltage regulators 58, 60 in the system or device 50. The main power supply 66 may include any conventional power supply, internal or external, including power supplies that provide regulated voltage outputs of any value. In the example shown in FIG. 2, the main power supply 66 may provide a voltage of, for example, approximately 3.3 volts which is applied to the voltage regulators 58, 60, 52 and to the supply line and bias line boosters 62, 64.

Controllable voltage regulators 58, 60 provide a second level of voltage regulation and control. In one example, voltage regulators 58, 60, when activated under the control of the activate signals 70A, 70B, generate a regulated supply voltage output 72, 74 (approximately 1.2 volts in this example). Specifically, voltage regulator 58 provides a regulated voltage 72 to subsystem 52. Voltage regulator 60 provides a regulated voltage 74 to subsystems 54, 56.

The supply boosters 62 may be used to assist one or more supply regulators 60. The one or more supply regulators 58, 60 are shown as a generic implementation. Depending on the requirements of a particular embodiment, there could be for example one, or ten or any number of supply regulators 58, 60. The designer can decide to add the booster 62 to only 2 out of 10 sub-blocks, for example, or in the case where there is only one regulator, the regulator may drive all 10 sub-blocks, and supply boosters 62 may be used as needed.

Once the internal or external main regulator 66 is activated, current or voltage is available to the device 50 to come out of sleep-mode or a power down state. Additional current pumping can be applied to the sub-blocks that are to come up first by activating a supply booster 62.

The supply line booster 62 can boost current to supply line 74. When current is applied to a capacitive load, the voltage increased may be characterized by (C*dV/dT=I). Once an expectable voltage level is reached, the additional pump current circuit can be disabled. The same concept can be applied to bring various internal nodes or signals of device 50 to their operating points faster through the use of bias line booster 64.

As described below, the boost circuits 62, 64 can be used to indicate once a subsystem or node has reached a proper voltage level (i.e., ready to receive or transmit data) which can help to power up other sub-blocks in a specific sequence.

In FIG. 2, a supply booster circuit 62 is shown coupled with the regulated voltage output 74 of voltage regulator 60 so that supply booster 62 can boost or supplement the supply voltages 74 to subsystems 54, 56 as needed for faster start-up timing if desired.

A bias line booster circuit 64 is coupled with a bias signal 76 between subsystems 54 and 56, in this example. Bias line booster 64 can be used to boost a bias signal or other signal within a circuit 50 as desired, to provide for faster start-up timing if desired.

As shown in FIG. 2, supply booster 62 may include a comparator 80 which can be activated or deactivated through a control signal 70C as shown in FIG. 2, and a current source 82.

In FIG. 2, the same control signal may be coupled with signals 70B, 70C, 70D or voltage regulator 60, supply booster 62 and bias line booster 64, in one example. If desired, a separate control signal may activate voltage regulator 58. In this way, by having separate control signals for activating voltage regulators 58, 60, the subsystems 52 and 54, 56 to which these voltage regulators are coupled with can be prioritized or staggered in terms of the power up timing or sequence. In one example, the control signals may come from a master control logic block which may be included as part of an integrated circuit or electronic device 50, or these control signals may be provided by an internal or external logic or timers, such as power and reset circuitry.

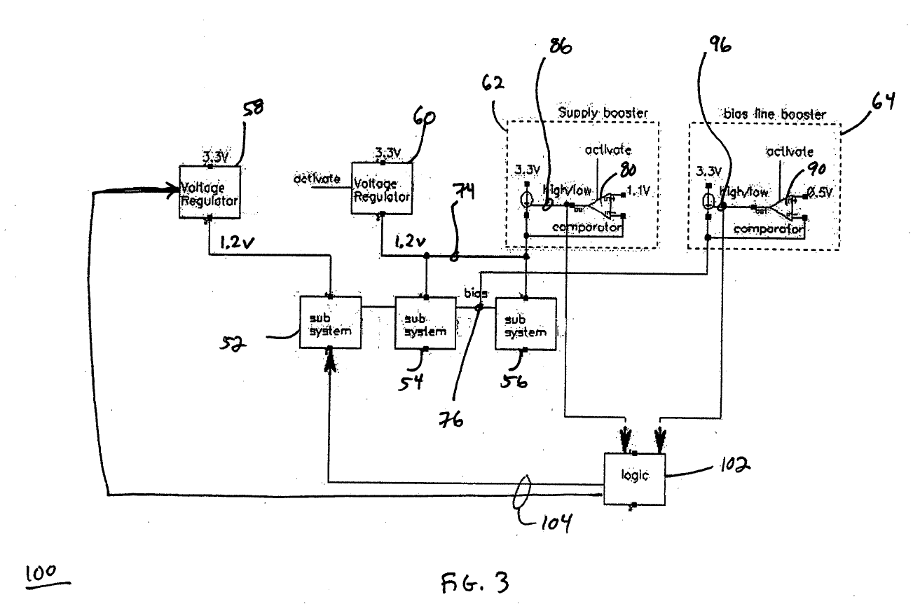

The supply booster 62 helps the voltage regulator 60 to come up faster and in a more predictable fashion in terms of the time for bringing the regulated output signal 74 to its desired voltage level. In one example, supply booster 62 adjusts the current connected to the voltage regulator output node 74 such that the output node 74 reaches the desired level in a faster time. In the example of FIGS. 2-3, voltage regulator 60 provides a regulated output voltage 74 of approximately 1.2 volts, and the supply booster 62 injects current into the regulated supply line 74 until the point at which the regulated supply line 74 reaches approximately 1.1 volts.

The non-inverting input of the comparator 80 can be coupled with a reference voltage 84, in this example shown as 1.1 volts, and the inverting input can be coupled with the regulated voltage supply line 74. A current source 82 can be activated based on the output 86 of the comparator 80, such that if the voltage present on the supply line 74 is less than the reference voltage 84, then the comparator output86 turns on the current source 82 which boosts the supply line 74 until the voltage present at the supply line 74 is equal to or greater than the reference voltage 84. This helps to speed up the start-up of subsystems 54, 56 to which the booster circuit 62 is coupled with.

Bias line booster 64 may include a comparator 90 which can be activated or deactivated through a control signal 70D. The non-inverting input of the comparator 90 can be coupled with a reference voltage 92, in this example shown as approximately 0.5 volts, and the inverting input can be coupled with the bias line 76 that is to be boosted. A current source 94 can be activated based on the output 96 of the comparator 90, such that if the voltage present on bias signal line 76 to be boosted is less than the reference voltage 92, then the comparator 90 turns on the current source 94 which boosts the bias signal line 76 until the voltage present is equal to or greater than the reference voltage 92.

In one example, the bias line booster 64 may be used to bring a bias line that is directed into a subsystem up to a particular value before the subsystem receives its power. For instance, in FIG. 2, a bias signal 76 is provided to subsystems 54, 56, and bias line booster 64 can boost the bias signal 76 up to a voltage, such as approximately 0.5 volts, before the subsystems 54, 56 have been fully powered up by voltage regulator 60 and supply booster 62. In such an example, the bias line booster 64 could receive an activate signal 70D before voltage regulator 60 and booster 62 receive activate signals 70B, 70C.

FIG. 3 shows an alternate voltage regulator arrangement 100 using the comparator outputs 86, 96 and logic 102 to “gate” undesirable signals or to power up sub-blocks in a specific sequence. In FIG. 3, the outputs 86, 96 of the comparators 80, 90 are driven into logic 100, which generates control outputs 104. The comparator output 86, 96 indicate when the voltage on a particular sub-block or bias line has reached a desired voltage level. The logic 100 can be used to decide which sub-block should be powered up next based on the information from the comparators 80, 90. For example, once comparator outputs 86, 96 are high (indicating acceptable voltage levels), only then logic 100 powers up sub-block 52 or a reset signal can be turned off, or other action can be taken. As with FIG. 2, it is to be appreciated that FIG. 3 is provided for illustrative purposes only and that one or more signals from booster 62, from booster 64, or both, may be used in various manners by device or system 50 for controllably applying power to subsystems in a sequential manner.

In FIG. 3, voltage regulator 58 provides a regulated voltage supply signal to subsystem 52. Voltage regulator 60 provides a regulated voltage supply signal to subsystems 54, 56. Supply booster 62 operates to boost the supply lines 74 to subsystems 54, 56. Bias line booster 64 boosts the bias signal 76 between subsystems 54, 56.

In FIG. 3, logic 102 may be provided which, in this example, receives the outputs 86, 96 of the comparators 80, 90 of boosters 62, 64 which monitor the regulated voltage output of voltage regulator 60 and the bias signal 76 provided between subsystems 54, 56. The output of logic 102 may be used to activate the power applied to subsystem 52, in this example. For instance, once the voltage regulator 60 has reached a sufficiently high voltage as detected by the comparator 80 of supply booster 62, logic 102 may then activate voltage regulator 58, which supplies voltage to subsystem 52. In this way, subsystems 54, 56 receive power before subsystem 52.

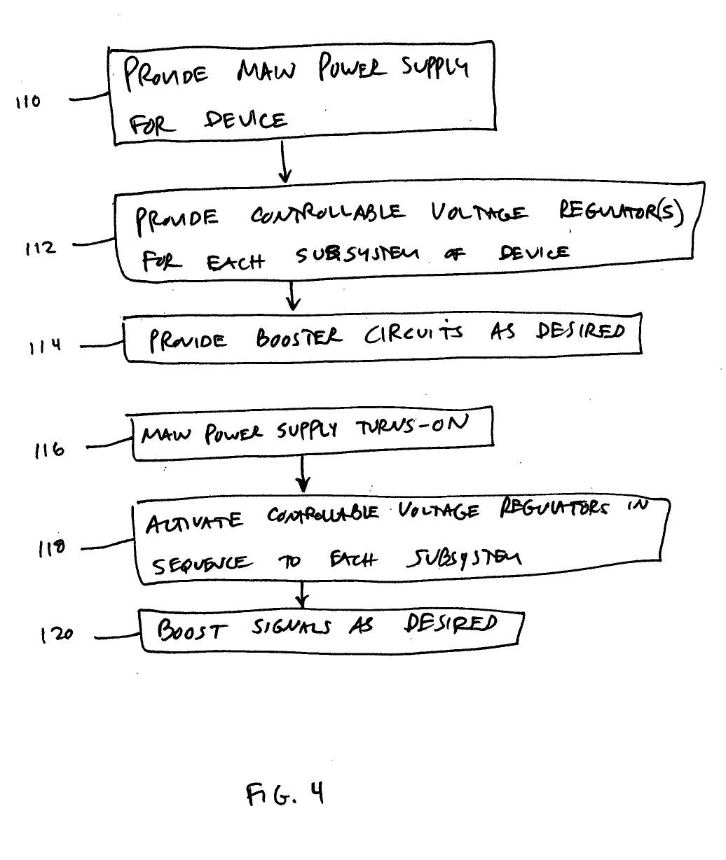

FIG. 4 illustrates an example of operations for improving device power up timing and predictability, in accordance with one embodiment of the present invention. It is understood that one or more of the operations of FIG. 4 may be applied to a device or system, wherein the device or system may be integrated within a single integrated circuit, or distributed amongst a plurality of integrated circuits or discrete components.

In one example, the method may include the operations of selectively providing a first supply voltage to a first subsystem, detecting when the first supply voltage has reached a predetermined value, and selectively providing a second supply voltage to a second subsystem. In one example, the operation of selectively providing a second supply voltage occurs after the detecting operation, and the detecting operation may include comparing the first supply voltage to a reference voltage. In this manner, the first subsystem of the integrated circuit is powered-up before the second supply voltage is applied to the second subsystem—this provides for controlled, sequential power up of the subsystems of the integrated circuit.

Of course, if desired, the integrated circuit could be designed so that the second subsystem receives its regulated supply before the first subsystem, or other sequences are possible where there are numerous subsystems in the integrated circuit. For instance, this methodology could be applied to integrated circuits having multiple and numerous subsystems that are to be sequentially powered up in a desired order to avoid the problems identified above with conventional systems.

In another example, the method may also include boosting the first supply voltage to provide for faster power-up of the first supply voltage and the first subsystem. The method may also include boosting the second supply voltage to provide for faster power-up of the second supply voltage and the second subsystem. Signals within or between subsystems that are bias signals or voltages may also be boosted or pre-biased for faster startup, so that these bias signals are providing their desired bias levels in a rapid time, which helps to improve the startup time of the subsystem containing the boosted bias signal.

Referring to the example of FIG. 4, at operation 110, a main power supply is provided for the device or system. The main power supply may be any conventional power supply and provides a first level of power for the device or system. At operation 112, controllable voltage regulators are provided for one or more subsystems of the device. Preferably, in one example, the device or system is divided into subsystems, and for each subsystem, a controllable voltage regulator is associated with the subsystem and provides controllable regulated power to that corresponding subsystem. In one example, the controllable voltage regulators provide a second level of voltage regulation to the system or device, as the controllable voltage regulators receive the first level of voltages provided by the main power supply of operation 110.

At operation 114, one or more booster circuits may be provided as desired. For instance, a supply booster circuit may be provided for boosting the output voltages of the controllable voltage regulators when activated, or bias line booster circuits may be provided to boost bias signals utilized within subsystems of the device. It is understood that operation 114 is optional depending upon the particular implementation.

At operation 116, the main power supply is turned on. As indicated above, the main power supply may include any conventional power supply, and once the main power supply is turned on, a first level of voltage is provided within the device or system. At operation 118, the controllable voltage regulators are activated in a controlled sequence so as to provide regulated voltages, in a controlled sequence, to each subsystem of the system or device. In one example, a state machine or other logic or circuit may be utilized to sequentially activate the controllable voltage regulators as desired. At operation 120, booster circuits may be activated to provide signals to boost supply signals or bias signals, as desired. Depending upon the particular implementation, operations 118-120 may occur in sequence, in reverse order, or simultaneously, as desired.

Hence, it can be seen that embodiments of the present invention provide for selective control and prioritization of the application of power to subsystems of a device or system. In this way, the overall predictability and timing of the power of such a device or system is improved. Advantages of embodiments of the present invention may include faster start-up speed than conventional solutions; improved power up timing of internal circuits and signal (e.g. bias lines); and power-up occurs in a predictable manner so that the sub-blocks can come up in a predictable sequence. In addition, the boost circuits 62, 64 may be used (separately or together) as a sensor indicate when a particular subsystem is powered-up and ready to receive signals.

While examples of embodiments of the present invention have been described herein with reference to voltages such as 3.3 volts and 1.2 volts, it is understood that embodiments of the invention could be utilized with other operational voltages, and accordingly, the voltages utilized with particular embodiments of the present invention are a matter of choice depending upon the particular implementation.

Embodiments of the present invention may be used in various semiconductors, memories, processors, controllers, integrated circuits, logic or programmable logic, clock circuits, and the like.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed inventions require more features than are expressly recited in each claim. Rather, as the following claims reflect, inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

1. A voltage regulation system for a device having at least a first and second subsystem, comprising:
a main power supply providing a first supply voltage;
a first controllable voltage regulator receiving the first supply voltage and selectively providing a second supply voltage to the first subsystem beginning at a first time;
a second controllable voltage regulator receiving the first supply voltage and selectively providing a third supply voltage to the second subsystem beginning at a second time;
wherein the first and second times are different.

2. The voltage regulation system of claim 1, further comprising:
means for boosting the second supply voltage.

3. The voltage regulation system of claim 1, further comprising:
a supply booster circuit including a comparator and a current source for boosting the second supply voltage to a predetermined voltage, the supply booster circuit indicating when the second supply voltage for the first subsystem has reached the predetermined voltage.

4. The voltage regulation system of claim 1, wherein the first controllable voltage regulator includes a control signal for selectively activating the second supply voltage.

5. The voltage regulation system of claim 1, wherein the second controllable voltage regulator includes a control signal for selectively activating the third supply voltage.

6. The voltage regulation system of claim 1, wherein the first time occurs before the second time.

7. The voltage regulation system of claim 1, wherein the first time occurs after the second time.

8. The voltage regulation system of claim 1, wherein the main power supply is external to the device.

9. The voltage regulation system of claim 1, wherein the main power supply is internal to the device.

10. The voltage regulation system of claim 1, wherein the device is an integrated circuit and the first and second subsystems are within the integrated circuit.

11. A method of regulation of power within an integrated circuit, the integrated circuit having at least a first and a second subsystem therein, the method comprising:
selectively providing a first supply voltage to the first subsystem;
detecting when the first supply voltage has reached a predetermined value; and
selectively providing a second supply voltage to the second subsystem.

12. The method of claim 11, wherein the operation of selectively providing a second supply voltage occurs after the detecting operation.

13. The method of claim 11, further comprising:
boosting the first supply voltage.

14. The method of claim 11, further comprising:
boosting the second supply voltage.

15. The method of claim 11, wherein the detecting operation includes comparing the first supply voltage to a reference voltage.

16. An integrated circuit having at least a first and second subsystem, the integrated circuit comprising:
at least a first controllable voltage regulator receiving selectively providing a first supply voltage to the first subsystem;
at least a second controllable voltage regulator selectively providing a second supply voltage to the second subsystem; and
a comparator for determining when the first supply voltage has reached a predetermined value.

17. The integrated circuit of claim 16, wherein the predetermined value is a reference voltage.

18. The integrated circuit of claim 16, further comprising:
a boost circuit for boosting the first supply voltage.

19. The integrated circuit of claim 16, further comprising:
logic for controlling the second controllable voltage regulator.

20. The integrated circuit of 16, wherein the second controllable voltage regulator includes a control input for selectively activating the second supply voltage.
